(19) United States
(12) Patent Application Publication
(10) Pub. No.: US 2018/0085976 A1
(43) Pub. Date: Mar. 29, 2018

(54) DISPLAY PANEL AND MANUFACTURING METHOD THEREOF, DISPLAY DEVICE AND MOULD

(71) Applicants: BOE TECHNOLOGY GROUP CO., LTD., Beijing (JP); BEIJING BOE OPTOELECTRONICS TECHNOLOGY CO., LTD., Beijing (JP)

(72) Inventors: Yuguang FAN, Beijing (CN); Shichao WANG, Beijing (CN); Jian LI, Beijing (CN); Jingpeng LI, Beijing (CN); Zhenyu XIE, Beijing (CN)

(21) Appl. No.: 15/541,652

(22) PCT Filed: Jun. 3, 2016
(86) PCT No.: PCT/CN2016/084760

§ 371 Date: Jul. 5, 2017

(30) Foreign Application Priority Data
Feb. 24, 2016 (CN) 201610102414.4

(51) Int. Cl. B29C 45/14; B29C 45/26; B29C 45/40; B29C 45/00

(52) U.S. Cl. CPC B29C 45/14065; B29C 45/2608; B29C 45/40; B29C 2045/4078; B29C 2045/14114; B29C 2045/0058; B29C 45/0055

(57) ABSTRACT

A display panel, a manufacturing method thereof, a display device and a mould are disclosed. The display panel includes a first substrate and a second substrate disposed opposite to each other; a sealant disposed in a non-display region between the first substrate and the second substrate; and a protection structure disposed on a side surface of the display panel, wherein a material of forming the protection structure is an insulating material with viscosity; and a height of the protection structure in a direction perpendicular to surfaces of the first substrate and the second substrate is not greater than a thickness of the display panel.

### TECHNICAL FIELD

Embodiments of the present invention relate to a display panel and a manufacturing method thereof, a display device and a mould.

### BACKGROUND

At present, with the development of display technology, narrow-bezel technology has become one of selling points in the market. However, as for a thin film transistor liquid crystal display (TFT-LCD) and an organic light-emitting diode (OLED) display, a pure bezel-free design is difficult to implement in consideration of mechanism. Moreover, from aspect of technical proposals, existing narrow bezel designs more and more tend to be achieved by narrowing a space of peripheral circuits and sealant. Risks caused by such narrow bezel includes: circuits are increasingly disposed at edges but peripheral circuits cannot be well protected, which may result in electrostatic discharge (ESD); substrates may easily be separated from each other due to insufficient bonding power of the sealant with the narrowing of the bezel; and microscopic cracks may easily be generated when the display panel is broken during assembly process of modules.

### SUMMARY

Embodiments of the present disclosure provide a display panel and a manufacturing method thereof, a display device, and a mould, in order to solve at least one of the defects in existing narrow-bezel display devices including: peripheral circuits cannot be well protected which may result in electrostatic discharge (ESD); substrates may easily be separated from each other due to insufficient bonding power of the sealant with the narrowing of the bezel; and microscopic cracks may easily be generated when the display panel is broken during assembly process of modules.

In order to achieve the above objectives, embodiments of the present disclosure adopt technical solutions as below.

On one aspect, embodiments of the present invention provide a display panel including: a first substrate and a second substrate disposed opposite to each other; a sealant disposed in a non-display region between the first substrate and the second substrate; and a protection structure disposed on a side surface of the display panel, wherein a material of forming the protection structure is an insulating material with viscosity; and a height of the protection structure in a direction perpendicular to surfaces of the first substrate and the second substrate is not greater than a thickness of the display panel.

In an example, the protection structure is disposed at the same side of the first substrate and the second substrate by extending from a surface of the first substrate far away from the second substrate to a surface of the second substrate far away from the first substrate.

In an example, water absorption of the material of forming the protection structure is less than a default threshold; and the default threshold is a minimum water absorption that affects a normal operation of the display panel.

In an example, a lead region is disposed on one side of the second substrate of the display panel which is protruded over the first substrate; and the protection structure is disposed on one side of the second substrate of the display panel which is aligned with the first substrate.

In an example, a width of the protection structure in a direction perpendicular to the side surfaces of the first substrate and the second substrate is 0.001 μm-2 mm.

In an example, an outer surface of the protection structure is a cambered surface.

In an example, the material of forming the protection structure is a material of the sealant.

On another aspect, embodiments of the present invention provide a display device including the display panel provided by the above embodiments.

On yet another aspect, embodiments of the present invention provide a method of manufacturing the display panel of the above embodiments, including: fixing the display panel on which the protection structure is to be manufactured in a mould having a thickness not greater than that of the display panel in such a manner that an injection molding die cavity is formed by a side surface of the display panel on which the protection structure is to be manufactured and an inner surface of the mould; injecting a glue material into the injection molding die cavity; and stripping off the mould upon a molding of the glue material.

In an example, before fixing the display panel on which the protection structure is to be manufactured in a mould having a thickness not greater than that of the display panel, the method further includes: coating a demoulding agent for demoulding of the glue material on an inner surface of the injection molding die cavity.

In an example, before injecting a glue material into the injection molding die cavity, the method further includes: filling a stepped portion on one side of the display panel where a lead region is located by using a filling material.

In an example, before injecting a glue material into the injection molding die cavity, the method further includes: sealing a gap between the mould and the display panel by using a sealing film.

On still another aspect, embodiments of the present invention provide a mould applied in the method of above embodiments. The mould is a non-closed, hollow structure; an opening is formed at an inner side of the mould; and a depth of the opening is not greater than a thickness of the display panel on which the protection structure is to be manufactured.

In an example, an inner surface of the mould is a cambered surface.

### BRIEF DESCRIPTION OF THE DRAWINGS

Hereafter, the embodiments of the present invention will be described in a more detailed way with reference to the accompanying drawings, so as make one person skilled in the art be able to understand the present invention more clearly, wherein:

FIG. 1 is a schematic structural view of a display panel provided by an embodiment of the present invention;

FIG. 2 is a schematic structural view of a display panel including a lead region provided by an embodiment of the present invention;

FIG. 3 is a flow chart of a method of manufacturing the display panel provided by the embodiment of the present invention, provided by an embodiment of the present invention;

FIG. 4 is a top view illustrating a process of manufacturing a protection structure by injection molding, provided by an embodiment of the present invention; and

FIG. 5 is an overall flowchart of the method of manufacturing the display panel provided by the embodiment of the present invention, provided by the embodiment of the present invention.

### DETAILED DESCRIPTION

Hereafter, the technical solutions in the embodiments of the present disclosure will be described in a clearly and fully understandable way in connection with the drawings in the embodiments of the present disclosure. It is obvious that the described embodiments are just a part but not all of the embodiments of the disclosure. Based on the described embodiments herein, one person skilled in the art can obtain other embodiment(s), without any inventive work, which should be within the scope of the disclosure.

Unless otherwise defined, the technical terminology or scientific terminology used herein should have the same meaning as commonly understood by one of ordinary skill in the art to which this invention belongs. Likewise, terms like “first,” “second,” etc., which are used in the description and the claims of the present application for invention, are not intended to indicate any sequence, amount or importance, but distinguish various components. The phrases “connect”, “connected”, etc., are not intended to define a physical connection or mechanical connection, but may include an electrical connection, directly or indirectly. “On,” “under,” “left,” “right” or the like is only used to describe a relative positional relationship, and when the absolute position of a described object is changed, the relative positional relationship might also be changed accordingly.

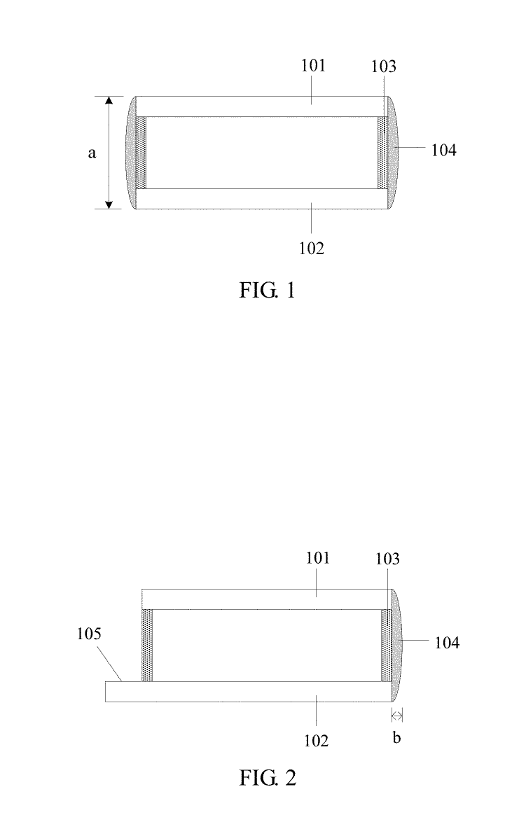

As illustrated in FIG. 1 which is a schematic structural view of a display panel provided by an embodiment of the present invention, the display panel includes: a first substrate 101 and a second substrate 102 disposed opposite to each other; a sealant 103 disposed in a non-display region between the first substrate 101 and the second substrate 102; and a protection structure 104 disposed on a side surface of the display panel. A material of forming the protection structure 104 is an insulating material with viscosity; and a height of the protection structure in a direction perpendicular to surfaces of the first substrate 101 and the second substrate 102 is not greater than a thickness of the display panel.

In the existing narrow-bezel display, circuits are disposed at edges but peripheral circuits cannon be well protected, which involves a risk of ESD. As a comparison, in the display panel provided by the embodiment of the present invention, a protection structure 104 made of insulating material is additionally arranged on the side surface, so the ESD of the peripheral circuits can be avoided. Meanwhile, in the existing narrow-bezel display, there is no protective layer at the periphery of the glass substrate which may easily break and generate microcracks during assembly process of modules. As a comparison, the protection structure 104 in the embodiment of the present invention may function for buffering, more and less, which may reduce the risk of breaking or generating microcracks of the display panel.

In one example, as illustrated in FIG. 1, the protection structure 104 is disposed on the same side of the first substrate and the second substrate by extending from a surface of the first substrate 101 far away from the second substrate 102 to a surface of the second substrate 102 far away from the first substrate 101.

In one example, in order to ensure that the protection structure 104 can be fixed on the side surface of the display panel, the material of forming the protection structure 104 may have viscosity. In existing technology, with narrower bezel, substrates may easily be separated from each other due to insufficient bonding power of sealant 103; According to the embodiment of the present invention, as the material with viscosity is adopted to form the protection structure 104, a bonding power is provided for the first substrate 101 and the second substrate 102 so that they cannot be easily separated.

In one example, in order not to affect the thickness of the display panel, a height of the protection structure 104 in a direction perpendicular to the surfaces of the first substrate 101 and the second substrate 102 is not greater than the thickness of the display panel, that is to say, supposing that a distance between an upper surface of the first substrate 101 and a lower surface of the second substrate 102 in FIG. 1 is a (namely the height of the protection structure 104 in the direction perpendicular to the first substrate 101 and the second substrate 102), a value of a is less than or equal to the thickness of the display panel.

There will be certain circuits exposed at the periphery, particularly at corners of the known sealant 103, and acid or moisture in the environment may erode the peripheral circuit to a certain degree. In one example, in order to protect the peripheral circuit from erosion, water absorption of the protection structure 104 is less than a default threshold. The default threshold is the minimum water absorption that may affect the normal operation of the display panel. Thus, the water absorption of the selected material of the protection structure 104 may be less than the default threshold (the default threshold is the minimum water absorption that may affect the normal operation of the display panel). Therefore, materials with low water absorption may be selected to form the protection structure 104, so as to prevent the peripheral circuit from being eroded by acid or moisture in the environment.

In one example, a lead region 105 may be disposed on a side surface of the display panel. FIG. 2 is a schematic structural view of a display panel including a lead region provided by the embodiment of the present invention. As illustrated in FIG. 2, the lead region 105 may be disposed on one side of the second substrate 102 of the display panel which is protruded over the first substrate 101, and the protection structure 104 is disposed on the other side which is not provided with the lead region 105. That is to say, the protection structure 104 is disposed at sides of the first substrate 101 and the second substrate 102 which are aligned with each other as illustrated in FIG. 2 (namely the right side in FIG. 2), and leads, instead of the protection structure 104, are disposed at sides of the first substrate 101 and the second substrate 102 which are not aligned with each other (namely the left side in FIG. 2), so that the influence on the normal operation of the display panel can be avoided.

The embodiments of the present invention are applicable for narrow-bezel designs, thus in order to prevent from increasing a width of the bezel, the thickness of the protection structure 104 may be as small as possible. In one example, the width of the protection structure 104 in the direction perpendicular to the side surfaces of the first substrate 101 and the second substrate 102 is 0.001 μm-2 mm. That is to say, assuming a section width of the protection structure 104 in the direction perpendicular to the side surfaces of the first substrate 101 and the second substrate 102 as illustrated in FIG. 2 is b, a value of b is 0.001 μm-2 mm.

In one example, as illustrated in FIG. 2, an outer surface of the protection structure 104 is a cambered surface. However, the shape of the protection structure 104 is not specifically defined in the embodiments of the present invention, as long as it provides protective function. For instance, the shape of a section of the protection structure 104 in the direction perpendicular to the side surfaces of the first substrate 101 and the second substrate 102 may be a closed U, a square, a rectangle, a trapezoid, a zigzag or a stepped shape. In general, the specific shape of the protection structure 104 is determined by the shape of an inner surface of a mould for manufacturing the protection structure; that is, the shape of the outer surface or the section of the protection structure is varied with the change of the shape of the inner surface of the mould, but may be any of shapes which are formed by demolding method using the mould and provide protective function.

The material of forming the protection structure 104 in the embodiment of the present invention may be any insulating material having viscosity and low water absorption. For instance, the material of forming the protection structure 104 is the material of the sealant. The specific material of the sealant may be any materials known for preparing the sealant.

As described above, a protection structure is additionally arranged on the side surface of the display panel provided by the embodiment of the present invention; on one hand, as the protection structure has insulation property, the ESD of the peripheral circuit can be avoided; and on the other hand, as the protection structure has viscosity, a certain bonding power can be provided for the first substrate and the second substrate; in addition, during the assembly process of modules, the protection structure may provide certain buffering function and hence reduce the risk of breaking and generating microscopic cracks of the display panel.

Based on the same invention concept, the embodiments of the present invention further provide a display device including the display panel provided by the embodiment of the present invention. As the principle of the display device for solving problems thereof is similar to that of the display panel, the embodiments of the display device may refer to the embodiments of the display panel. No further description will be given herein.

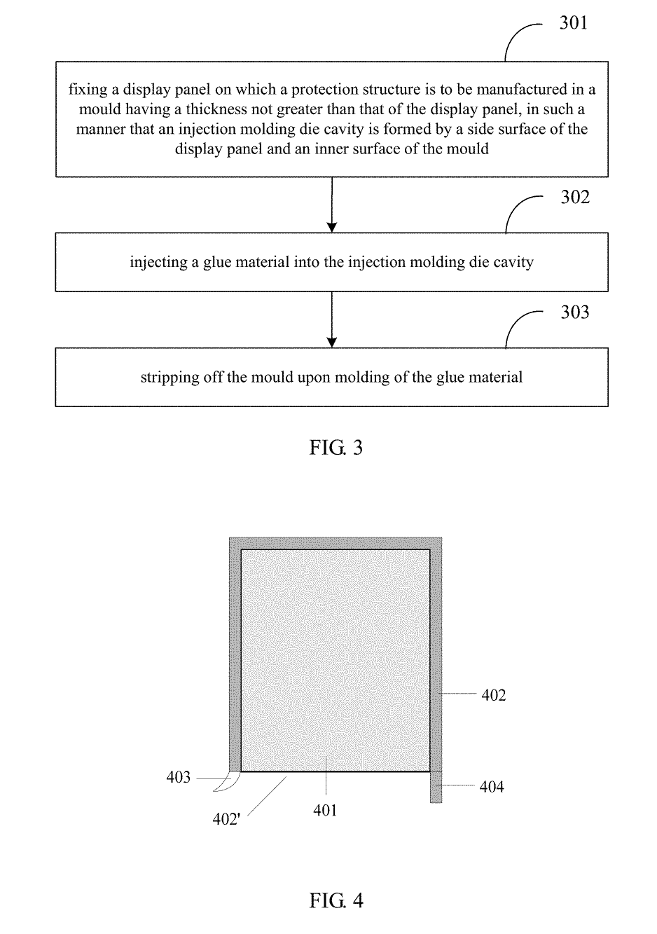

The embodiments of the present invention further provide a method of manufacturing the display panel provided by the embodiment of the present invention. FIG. 3 is a flow chart of one example of the method. The method includes steps as below.

S301: fixing a display panel on which a protection structure is to be manufactured in a mould having a thickness not greater than that of the display panel, in such a manner that an injection molding die cavity is formed by a side surface of the display panel and an inner surface of the mould;

S302: injecting a glue material into the injection molding die cavity; and

S303: stripping off the mould upon molding of the glue material.

In the embodiment of the present invention, the protection structure on the side surface of the display panel is manufactured by injection molding. Before the beginning of injection molding, the display panel on which the protection structure is to be manufactured is firstly fixed with the mould by fixing means which is not particularly defined herein, for instance, the display panel and the mould may be fixed by means of vacuum adsorption; secondly, the mould and the display panel are subjected to mechanical alignment, in which the thickness of the mould is not greater than the thickness of the display panel on which the protection structure is to be manufactured, and an injection molding die cavity is formed by the side surface of the display panel and the inner surface of the mould; thirdly, the glue material is sprayed into the injection molding die cavity under preset pressure, and the spraying process stops until the glue material flows out continuously through an exhaust port, in which the preset pressure is a spraying pressure (e.g., 1 MPa) determined according to the size of the mould; and fourthly, the glue material is heated and cured for 2-20 min at a temperature of 50-150° C., and then a demoulding process is performed at a temperature (the temperature may be adjusted according to the situation) higher than the room temperature until all the glue material in the die cavity is cured and molded, and the mould is stripped off.

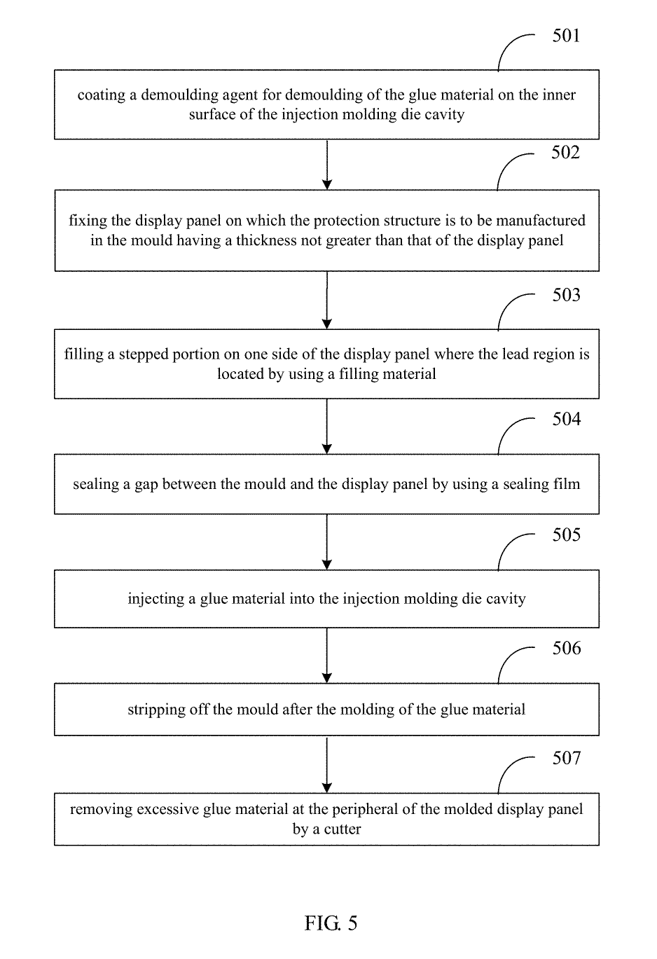

For clarity of illustration of the mould provided by the present invention, FIG. 4 is a top view of a protection structure manufactured by injection molding, provided by the embodiment of the present invention. FIG. 4 illustrates a display panel 401 on which a protection structure is to be manufactured, a mould 402, an exhaust port 403 or 404, and a glue injection opening 404 or 403. The glue injection opening is usually disposed at position 404 or 403; for example, if the glue injection opening is disposed at the position 404, the exhaust port is disposed at the position 403, vice versa. The exhaust port may be a tail pipe or other structures or units capable of facilitating the discharge of gas from the mould 402. FIG. 4 is only a schematic diagram illustrating the positional relationship between the mould 402 and the display panel 401 on which the protection structure is to be manufactured, and the specific shape of the mould may be adjusted according to the shape of the protection structure to be manufactured, without particularly defined herein.

In one example where the display panel includes the lead region, the lead region may be filled before injection molding. For instance, before the injection of the glue material into the injection molding die cavity, a filling material may be adopted to fill the stepped portion on one side of the display panel where the lead region is located, so that the lead region of the display panel can be filled to prevent the glue material from flowing into the lead region. For instance, the filling material may be polytetrafluoroethylene (PTFE) or other materials which will not react with the glue material or affect the leads on the display panel.

In one example, for the convenience of demoulding process, a layer of demoulding agent may be coated on a surface of the mould before injection molding. For instance, before the display panel on which the protection structure is to be manufactured is fixed in the mould having a thickness not greater than that of the display panel, a demoulding agent for the demoulding of the glue material may be coated on the inner surface of the injection molding die cavity. The material of the demoulding agent is not particularly defined herein and may be selected according to the material of the protection structure. For instance, the demoulding agent may be silica gel.

In one example, before injection molding, the mould may be fixed, and a gap between the mould and the display panel may be sealed; or, the display panel and the mould may be fully or partially sealed as required; as long as the case where overflow of the glue material due to gas leakage in the spray process or after the completion of the spray process can be avoided. For instance, before the injection of the glue material into the injection molding die cavity, a sealing film may also be adopted to seal the gaps between the mould and the display panel. For instance, the material of forming the sealing film may be rubber or polyurethane.

In one example, after the manufactured display panel is taken out, a surface of the protection structure as formed may be further processed. For instance, after the mould is stripped off, excessive glue material at the peripheral of the display panel as formed may be removed by a cutter; and the sealant for edge sealing is subjected to simple appearance shaping, so that the shape of the sealant can be smoother and also more regular.

For more clear description of the method of manufacturing the display panel provided by the embodiment of the present invention, as illustrated in FIG. 5, the overall flowchart of one example may include steps as below.

S501: coating a demoulding agent for demoulding of the glue material on the inner surface of the injection molding die cavity;

S502: fixing the display panel on which the protection structure is to be manufactured in the mould having a thickness not greater than that of the display panel;

S503: filling a stepped portion on one side of the display panel where the lead region is located by using a filling material;

S504: sealing a gap between the mould and the display panel by using a sealing film;

S505: injecting a glue material into the injection molding die cavity;

S506: stripping off the mould after the molding of the glue material; and

S507: removing excessive glue material at the peripheral of the molded display panel by a cutter.

On the basis of the same invention concept, the embodiments of the present invention further provide a mould which is applied in the method of manufacturing the display panel provided by the embodiment of the present invention.

As illustrated in FIG. 4, the mould 402 applied in the method of manufacturing the display panel provided by the embodiment of the present invention is a non-closed, hollow structure, and an opening 402′ is formed at an inner side of the mould 402. That is to say, the mould is a hollow structure similar to a recess, encircling the side surfaces of the display panel. The opening of the mould makes contact with the side surface of the display panel on which the protection structure is to be formed so as to form an injection molding die cavity therewith.

In one example, in order to ensure that the height of the manufactured protection structure does not exceed the thickness of the display panel, a depth of the opening 402′ in the mould is not greater than the thickness of the display panel on which the protection structure is to be manufactured.

In one example, as illustrated in FIG. 4, the shape of a section of the mould in a direction parallel to the display panel is a right-angled U, namely the shape of the mould is a right-angled U when viewed from the top of the display panel. The shape of an inner surface of the mould may be designed according to the shape of the protection structure to be manufactured, namely the shape of the inner surface of the mould is the same with the shape of an outer surface of the manufactured protection structure. For instance, the inner surface of the mould may be a cambered surface. For protection structures with different shapes, the inner surface of the mould may be a U-shaped surface, a right-angled U-shaped surface, a stepped surface, a saw-shaped surface, etc.

Obviously, various modifications and deformations can be made to the present invention by those skilled in the art without departing from the spirit and scope of the present invention. Therefore, the present invention is intended to include the modifications and deformations fallen within the scope of the appended claims and equivalents thereof.

The present application claims the benefits of Chinese patent application No. 201610102414.4 filed with the SIPO on Feb. 24, 2016 under the title “DISPLAY PANEL AND MANUFACTURING METHOD THEREOF, DISPLAY DEVICE AND MOULD”, which is incorporated herein by reference as part of the application.

1. A display panel, comprising:
a first substrate and a second substrate disposed opposite to each other;
a sealant disposed in a non-display region between the first substrate and the second substrate; and
a protection structure disposed on a side surface of the display panel, wherein
a material of forming the protection structure is an insulating material with viscosity; and a height of the protection structure in a direction perpendicular to surfaces of the first substrate and the second substrate is not greater than a thickness of the display panel.

2. The display panel according to claim 1, wherein the protection structure is disposed at a same side of the first substrate and the second substrate by extending from a surface of the first substrate far away from the second substrate to a surface of the second substrate far away from the first substrate.

3. The display panel according to claim 1, wherein water absorption of the material of forming the protection structure is less than a default threshold; and the default threshold is a minimum water absorption that affects a normal operation of the display panel.

4. The display panel according to claim 1, wherein a lead region is disposed on one side of the second substrate of the display panel which is protruded over the first substrate; and the protection structure is disposed on one side of the second substrate of the display panel which is aligned with the first substrate.

5. The display panel according to claim 1, wherein a width of the protection structure in a direction perpendicular to the side surfaces of the first substrate and the second substrate is 0.001 μm-2 mm.

6. The display panel according to claim 1, wherein an outer surface of the protection structure is a cambered surface.

7. The display panel according to claim 1, wherein the material of forming the protection structure is a material of the sealant.

8. A display device, comprising a display panel, the display panel comprises:
a first substrate and a second substrate disposed opposite to each other;
a sealant disposed in, a non-display region between the first substrate and the second substrate; and
a protection structure, disposed on a side surface of the display panel, wherein
a material of forming the protection structure is an insulating material with viscosity; and a height of the protection structure in a direction perpendicular to surfaces of the first substrate and the second substrate is not greater than a thickness of the display panel.

9. A method of manufacturing a display panel, the display panel comprises:
a first substrate and a seco substrate disposed opposite to each other;
a sealant disposed in a non-display region between the first substrate and the second substrate; and
a protection structure disposed on a side surface of the display panel, wherein
a material of forming the protection structure is an insulating material with viscosity; and a height of the protection structure in a direction perpendicular to surfaces of the first substrate and the second substrate is not greater than a thickness of the display panel,
the method comprises:
fixing the display panel on which the protection structure is to be manufactured in a mould having a thickness not greater than that of the display panel in such a manner that an injection molding die cavity is formed by a side surface of the display panel on which the protection structure is to be manufactured and an inner surface of the mould;
injecting a glue material into the injection molding die cavity; and
stripping off the mould upon a molding of the glue material.

10. The method according to claim 9, wherein before fixing the display panel on which the protection structure is to be manufactured in a mould having a thickness not greater than that of the display panel, the method further comprises:
coating a demoulding agent for demoulding of the glue material on an inner surface of the injection molding die cavity.

11. The method according to claim 9, wherein before injecting a glue material into the injection molding die cavity, the method further comprises:
filling a stepped portion on one side of the display panel where a lead region is located by using a filling material.

12. The method according to claim 11, wherein before injecting a glue material into the injection molding die cavity, the method further comprises:
sealing a gap between the mould and the display panel by using a sealing film.

13. A mould applied in the method according to claim 9, wherein the mould is a non-closed, hollow structure; an opening is formed at an inner side of the mould; and a depth of the opening is not greater than a thickness of the display panel on which the protection structure is to be manufactured.

14. The mould according to claim 13, wherein an inner surface of the mould is a cambered surface.

15. The display device according to claim 8, wherein the protection structure is disposed at a same side of the first substrate and the second substrate by extending from a surface of the first substrate far away from the second substrate to a surface of the second substrate far away from the first substrate.

16. The display device according to claim 8, wherein water absorption of the material of forming the protection structure is less than a default threshold; and the default threshold is a minimum water absorption that affects a normal operation of the display panel.

17. The display device according to claim 8, wherein a lead region is disposed on one side of the second substrate of the display panel which is protruded over the first substrate; and the protection structure is disposed on one side of the second substrate of the display panel which is aligned with the first substrate.

18. The display device according to claim 8, wherein a width of the protection structure in a direction perpendicular to the side surfaces of the first substrate and the second substrate is 0.001 μm-2 mm.

19. The display device according to claim 8, wherein an outer surface of the protection structure is a cambered surface.
